(19) United States
(12) Patent Application Publication
(10) Pub. No.: US 2002/0070480 A1
(43) Pub. Date: Jun. 13, 2002

(54) Method and apparatus for forming vibration isolating rubber bushes, and jig for attaching metal parts which is to be used in the method of forming vibration isolating rubber bushes

(76) Inventors: Toshihiro Watanabe, Osaka (JP); Osamu Nakai, Osaka (JP)

Correspondence Address: JORDAN AND HAMBURG LLP, 122 East 42nd Street, New York, NY, 10168, US

(21) Appl. No.: 09/767,401

(22) Filed: Jan. 23, 2001

(30) Foreign Application Priority Data
Dec. 7, 2000 (JP) 2000-372942

(51) Int. Cl. B29C 70/68; B29C 43/18

(52) U.S. Cl. 264/262; 264/268; 425/123; 425/124

(57) ABSTRACT

In a method of forming vibration isolating rubber bushes, a metal part attaching jig is first prepared. The metal part attaching jig includes: a guide member having a plurality of guide holes which droppingly guide a plurality of metal parts to a plurality of metal part receiving recesses of a lower mold half, respectively; and a guide hole opening and closing member which can open the guide holes by one action in a state where the metal parts inserted into the guide holes are received. The metal parts are inserted into the guide holes, respectively, after the guide hole opening and closing member is switched to a closing side. The guide hole opening and closing member is then switched to an opening side to cause the metal parts to be dropped and accommodated into the metal part receiving recesses.

### BACKGROUND OF THE INVENTION

1. Field of the Invention

The present invention relates to a technique of forming vibration isolating rubber bushes, and more particularly to a method and an apparatus for forming vibration isolating rubber bushes, and a jig for attaching metal parts which is to be used in the method of forming vibration isolating rubber bushes.

2. Description of the Related Art

In a conventional method of forming vibration isolating rubber bushes, when a plurality of ring-like metal parts are to be respectively placed in a plurality of metal part receiving recesses of a lower mold half, the worker places one by one the metal parts in the part receiving recesses of the lower mold half. In such a method wherein the worker places one by one metal parts in the part receiving recesses of the lower mold half, a considerably long time period must elapse from placing of the first metal part in a part receiving recess of the lower mold half till that of the last metal part in another part receiving recess.

With respect to the first metal part, therefore, the time period when the metal part is heated by the lower mold half of an elevated temperature is prolonged, and the temperature of the metal part is raised. Therefore, a rubber-bonding adhesive agent which is applied to the metal part is chemically changed before vulcanization bonding of an unvulcanized rubber composition, with the result that it is difficult to attain a desired adhesive strength.

A vibration isolating rubber bush in which such an adhesive failure occurs is judged as a defective. Therefore, a method of forming vibration isolating rubber bushes of the conventional art is low in yield, and there is still great room for improvement in the method.

### SUMMARY OF THE INVENTION

It is an object of the invention to provide a technique which can improve the yield in the case where a plurality of vibration isolating rubber bushes are formed by using upper and lower mold halves.

In order to attain the object, the characteristic configuration of the method of forming vibration isolating rubber bushes according to the invention is that the method comprises the steps of:

placing a plurality of metal parts in a plurality of metal part receiving recesses which are formed in a lower mold half, respectively;

laying an upper mold half on the lower mold half; and

vulcanization bonding an unvulcanized rubber composition to the plurality of metal parts, thereby forming a plurality of vibration isolating rubber bushes,

a metal part attaching jig is prepared, the metal part attaching jig including: a guide member having a plurality of guide holes which droppingly guide the plurality of metal parts to the plurality of metal part receiving recesses of the lower mold half, respectively; and a guide hole opening and closing member which can open the plurality of guide holes by one action in a state where the metal parts inserted into the guide holes are received,

the plurality of metal parts are inserted into the plurality of guide holes, respectively, after the guide hole opening and closing member is switched to a closing side, and the guide hole opening and closing member is then switched to an opening side to cause the plurality of metal parts to be dropped and accommodated into the plurality of metal part receiving recesses.

In this case, a metal part attaching jig is prepared, the jig including:

a guide member having a plurality of guide holes which droppingly guide the plurality of metal parts to the plurality of metal part receiving recesses of the lower mold half, respectively; and

a guide hole opening and closing member which can open the plurality of guide holes by one action in a state where the metal parts inserted into the guide holes are received.

Then, the guide hole opening and closing member is switched to a closing side, and the metal parts are respectively inserted into the guide holes, so that the metal parts are received by the guide hole opening and closing member.

Next, the thus configured metal part attaching jig is positioned in a state where the metal parts are located above the metal part receiving recesses of the lower mold half, and the guide hole opening and closing member is then switched to the opening side to cause the metal parts to be dropped all at once and accommodated into the metal part receiving recesses.

This enables all the metal parts to be heated by the lower mold half of an elevated temperature for a substantially same time period, thereby preventing a phenomenon in which some of the metal parts are heated for an excessively long time period, from occurring.

As a result, it is possible to suppress the disadvantage that, during a period from accommodating the metal parts into the metal part receiving recesses of the lower mold half to vulcanization bonding of an unvulcanized rubber composition, a rubber-bonding adhesive agent which is applied to the metal parts is chemically changed.

Since the disadvantage that, during a period from accommodating the metal parts into the metal part receiving recesses of the lower mold half to vulcanization bonding of an unvulcanized rubber composition, a rubber-bonding adhesive agent which is applied to the metal parts is chemically changed can be suppressed, the yield in the case where a plurality of vibration isolating rubber bushes are simultaneously produced by using upper and lower mold halves can be improved.

The characteristic configuration of the apparatus for forming vibration isolating rubber bushes according to the invention is that the apparatus comprises:

an upper mold half;

a lower mold half which can be laid below the upper mold half, which has a plurality of metal part receiving recesses for respectively accommodating a plurality of metal parts, and which is used for vulcanization bonding an unvulcanized rubber composition to the plurality of metal parts to form a plurality of vibration isolating rubber bushes; and

a metal part attaching jig comprising a guide member and a guide hole opening and closing member,

the guide member having a plurality of guide holes which droppingly guide the plurality of metal parts to the plurality of metal part receiving recesses of the lower mold half, respectively,

the guide hole opening and closing member being able to open the plurality of guide holes by one action in a state where the metal parts inserted into the guide holes are received.

According to this configuration, it is possible to suppress the disadvantage that, during a period from accommodating the metal parts into the metal part receiving recesses of the lower mold half to vulcanization bonding of an unvulcanized rubber composition, a rubber-bonding adhesive agent which is applied to the metal parts is chemically changed. Therefore, the yield in the case where a plurality of vibration isolating rubber bushes are simultaneously produced by using upper and lower mold halves can be improved.

The characteristic configuration of the jig for attaching metal parts according to the invention is that the jig is usable in the above-mentioned apparatus for forming vibration isolating rubber bushes, and comprises: a guide member having a plurality of guide holes which droppingly guide the plurality of metal parts to the plurality of metal part receiving recesses of the lower mold half, respectively; and a guide hole opening and closing member which can open the plurality of guide holes by one action in a state where the metal parts inserted into the guide holes are received.

According to this configuration, the guide hole opening and closing member is switched to a closing side, and the metal parts are respectively inserted into the guide holes, so that the metal parts are received by the guide hole opening and closing member,

the thus configured metal part attaching jig is positioned in a state where the metal parts are located above the metal part receiving recesses of the lower mold half, and the guide hole opening and closing member is switched to the opening side to cause the metal parts to be dropped all at once and accommodated into the metal part receiving recesses.

This enables all the metal parts to be heated by the lower mold half of an elevated temperature for a substantially same time period, thereby preventing a phenomenon in which some of the metal parts are heated for an excessively long time period, from occurring.

As a result, it is possible to suppress the disadvantage that, during a period from accommodating the metal parts into the metal part receiving recesses of the lower mold half to vulcanization bonding of an unvulcanized rubber composition, a rubber-bonding adhesive agent which is applied to the metal parts is chemically changed.

Therefore, the yield in the case where a plurality of vibration isolating rubber bushes are simultaneously produced by using upper and lower mold halves can be improved.

### BRIEF DESCRIPTION OF THE DRAWINGS

FIGS. 1(a) to 1(e) are views showing a method of forming vibration isolating rubber bushes;

FIG. 2 is a longitudinal section view of a jig for attaching metal parts;

FIG. 3 is a plan view of the jig for attaching metal parts; and

FIGS. 4(a) and 4(b) are views showing a vibration isolating rubber bush.

### DETAILED DESCRIPTION OF THE PREFERRED EMBODIMENT

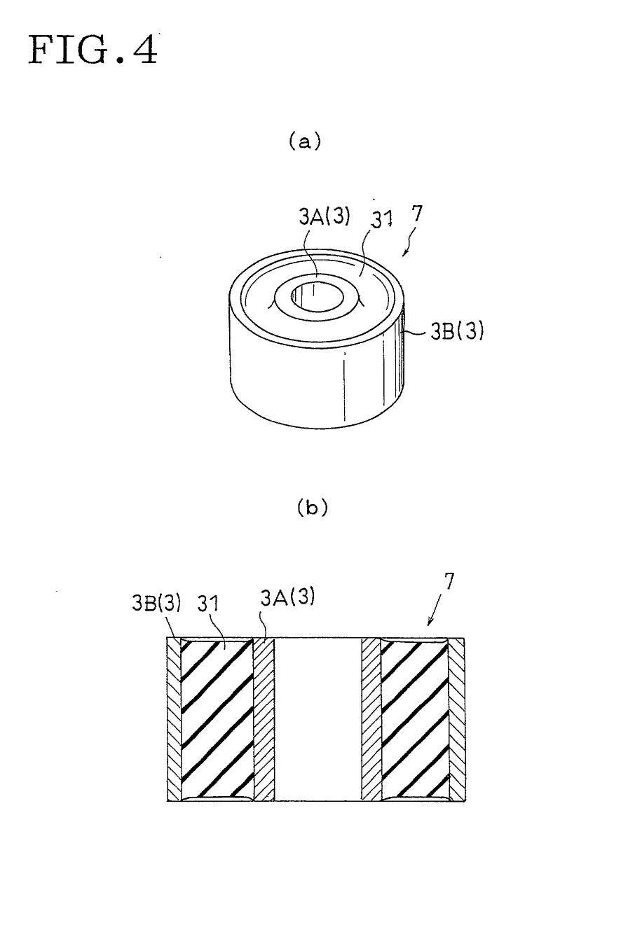

An embodiment of the method of forming vibration isolating rubber bushes according to the invention will be described with reference to the accompanying drawings. FIGS. 4(a) and 4(b) show a vibration isolating rubber bush 7 which is configured by disposing a rubber material layer 31 between ring-like inner and outer metal parts 3A and 3B. The vibration isolating rubber bush 7 is used as, for example, a part of an automobile.

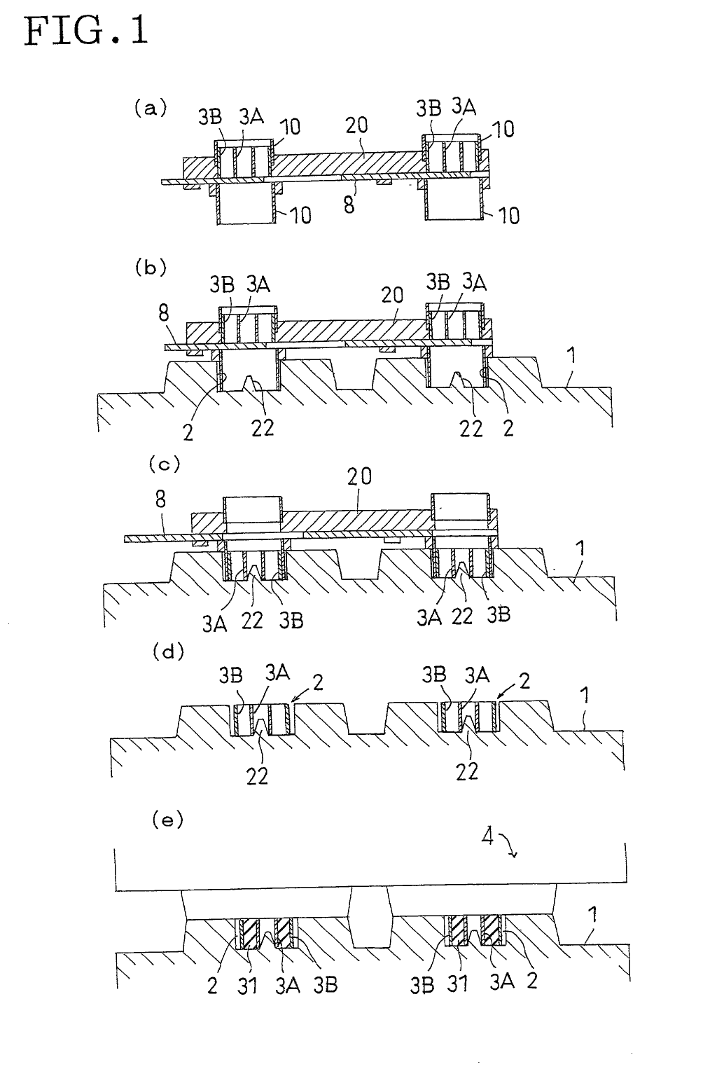

The method of forming vibration isolating rubber bushes of the embodiment is conducted by using an apparatus for forming vibration isolating rubber bushes which comprises a lower mold half 1 and an upper mold half 4, and which further comprises a metal-part attachment jig that is to be attached to the lower mold half 1. The whole of the method is shown in FIGS. 1(a) to 1(e). The method comprises the steps of:

(1) respectively accommodating a plurality of metal part sets 3 (each of the metal part sets 3 consists of the inner metal part 3A and the outer metal part 3B) into a plurality of metal part receiving recesses 2 which are formed in the lower mold half 1 so as to be arranged in two rows; and

(2) laying the upper mold half 4 on the lower mold half 1, and vulcanization bonding an unvulcanized rubber composition to the plurality of metal part sets 3, thereby forming a plurality of vibration isolating rubber bushes 7.

The method will be described in further detail later.

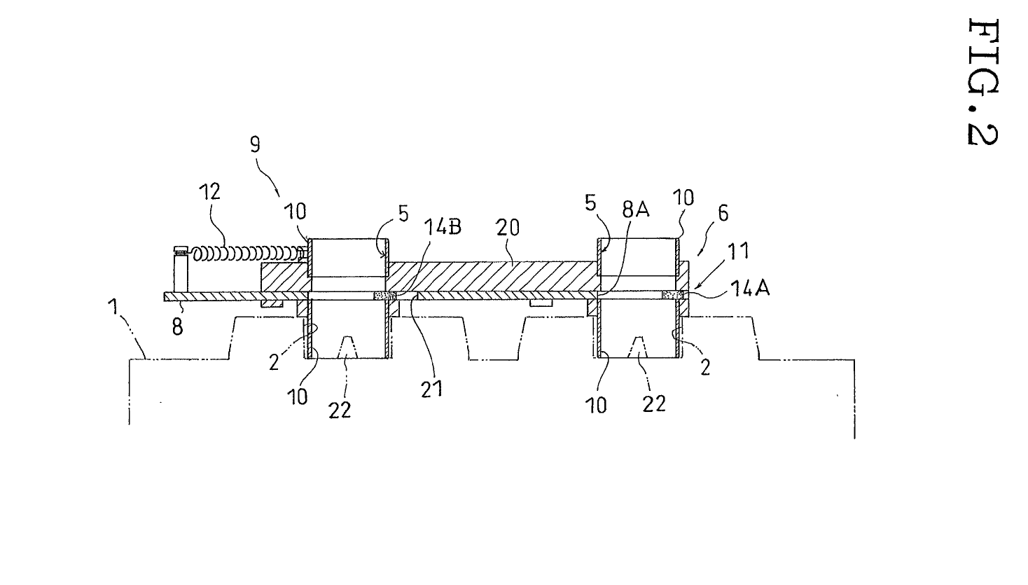

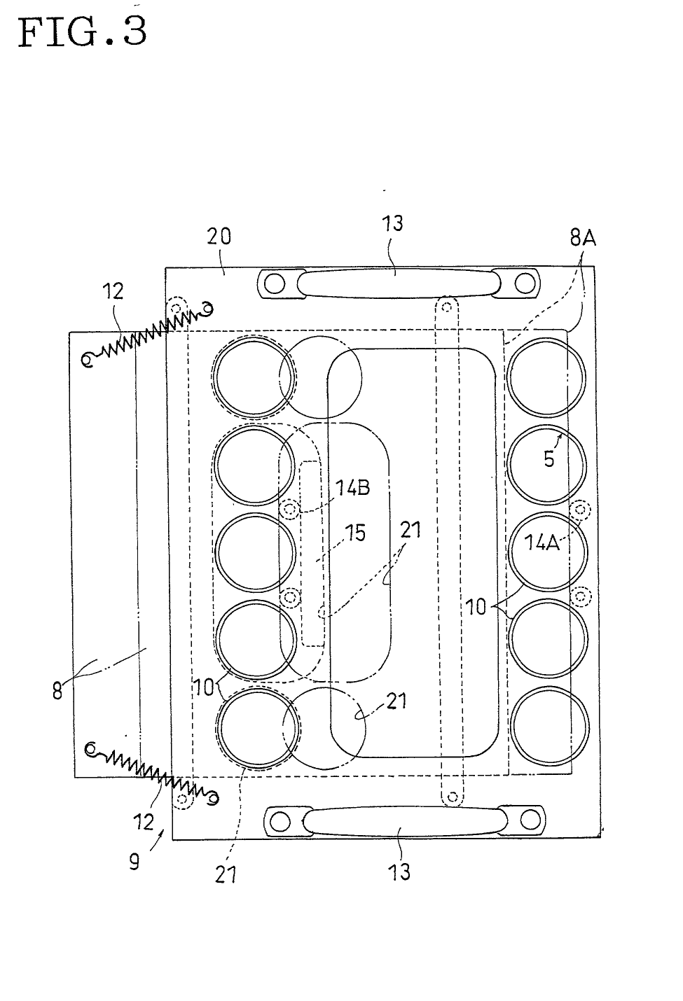

In the above-mentioned method of forming vibration isolating rubber bushes, as shown in FIGS. 2 and 3, the metal-part attachment jig 9 consisting of a guide member 6 and a guide hole opening and closing member 8 is used. The guide member 6 comprises a plurality of guide holes 5 which droppingly guide the plurality of metal part sets 3 to the plurality of metal part receiving recesses 2 of the lower mold half 1, respectively. The guide hole opening and closing member 8 can open the guide holes 5 by one action in a state where the metal part sets 3 inserted into the guide holes 5 are received.

This will be described in more detail. The guide member 6 is configured by forming a plurality of through holes in a main unit 20 in which a slide groove 11 for slidingly moving the guide hole opening and closing member 8 is formed. In each of the through holes, cylindrical guide rings 10 are fitted into upper and lower through hole portions so as to upward and downward protrude therefrom, respectively.

The guide hole opening and closing member 8 is slidably inserted into the slide groove 11 of the guide member 6, and urged toward the closing side by a plurality of springs 12.

A plurality of openings 21 (including circular openings and an oblong opening) through which the guide holes 5 can be opened in an opening state are formed in the guide hole opening and closing member 8.

In FIGS. 2 and 3, the reference numeral 13 denotes handles disposed on the guide member 6, and 14A denotes first stoppers which receive an end face 8A of the guide hole opening and closing member 8 to define the closing position of the guide hole opening and closing member 8. The reference numeral 14B denotes second stoppers which receive one inner wall of the oblong opening 21 to define the closing position of the guide hole opening and closing member 8. The reference numeral 15 denotes a third stopper which receives the other inner wall of the oblong opening 21 to define the opening position of the guide hole opening and closing member 8.

The size of the guide hole opening and closing member 8 is set so that, in the opening state, the guide holes 5 are positioned in the outer side with respect to the end face 8A of the guide hole opening and closing member 8.

According to the structure described above, when the guide hole opening and closing member 8 is pulled against the urging force of the springs 12, the other inner wall of the oblong opening 21 abuts against the third stopper 15, so that the opening position is defined to attain the opening state.

In other words, the openings 21 vertically overlap with the guide holes 5, and a state is attained in which, among the guide holes 5, one row of guide holes 5 which are arranged in a direction perpendicular to the sliding movement direction of the guide hole opening and closing member 8 are opened. Also the other row of guide holes 5 are positioned in the outer side with respect to the end face 8A of the guide hole opening and closing member 8, to enter the opening state.

When the pulling force is released from the guide hole opening and closing member 8, the urging force of the springs 12 causes the end face of the guide hole opening and closing member 8 to abut against the first stoppers 14A. The one inner wall of the oblong opening 21 abuts against the second stoppers 14B to define the closing position, thereby attaining the closing state.

Next, the method of forming vibration isolating rubber bushes will be described (see FIGS. 1(a) to 1(e)).

(1) The above-described metal-part attachment jig 9 is prepared.

(2) The guide hole opening and closing member 8 of the metal-part attachment jig 9 is set to the closing state by the urging force of the springs 12. In the closing state, the plurality of metal part sets 3 are placed in the upper guide rings 10, respectively (FIG. 1(a)).

(3) In each of the metal part sets 3, the inner metal part 3A is placed concentrically with the outer metal part 3B as far as possible, although the inner metal part may be placed in any positioned inside the outer metal part 3B (the reason of this will be described in (5) below).

(4) The metal-part attachment jig 9 is positioned with respect to the lower mold half 1 so that the metal part sets 3 are positioned above the metal part receiving recesses 2 of the lower mold half 1 (FIG. 1(b)).

This positioning is performed by fitting positioning holes (not shown) on the side of the metal-part attachment jig 9 are fitted onto positioning pins (not shown) disposed on the lower metal half 1.

(5) The guide hole opening and closing member 8 is pulled against the urging force of the springs 12 (FIG. 1(c)).

As a result, the guide holes 5 are set to be in the open state, and the metal part sets 3 are dropped and accommodated into the metal part receiving recesses 2 of the lower mold half 1 through the openings 21 of the guide hole opening and closing member 8 and the space which is outside the end face of the guide hole opening and closing member 8, respectively.

Even when the inner metal part 3A is placed in any position inside the outer metal part 3B, the inner metal part is guided by an upward-directed guide pin 22 which is disposed on the lower metal half 1, to define the position with respect to the outer metal part 3B.

(6) The metal-part attachment jig 9 is removed away (FIG. 1(d)), and the upper mold half 4 is laid on the lower metal half 1 (FIG. 1(e))

(7) An unvulcanized rubber composition is vulcanization bonded to the metal part sets 3, thereby forming a plurality of vibration isolating rubber bushes 7.

(8) The upper mold half 4 is raised, and the vibration isolating rubber bushes 7 are taken out from the lower metal half 1.

[Other Embodiments]

(1) The vibration isolating rubber bush according to the invention is not restricted to have the shape shown in FIGS. 4(a) and 4(b), and may have various inner diameters, outer shapes, and lengths. With using the structure shown in FIG. 4 as a basic one, various modifications such as that in which a flange is formed on the outer periphery, that which has a drawn structure, and that in which the inner metal part is prolonged from the outer metal part may be employed.

(2) The vibration isolating rubber bush 7 may be used as a part other than that of an automobile.

What is claimed is:

1. A method of forming vibration isolating rubber bushes comprising the steps of:
placing a plurality of metal parts in a plurality of metal part receiving recesses which are formed in a lower mold half, respectively;
laying an upper mold half on said lower mold half; and
vulcanization bonding an unvulcanized rubber composition to said plurality of metal parts, thereby forming a plurality of vibration isolating rubber bushes,
wherein
a metal part attaching jig is prepared, said metal part attaching jig including: a guide member having a plurality of guide holes which droppingly guide said plurality of metal parts to said plurality of metal part receiving recesses of said lower mold half, respectively; and a guide hole opening and closing member which can open said plurality of guide holes by one action in a state where said metal parts inserted into said guide holes are received,
said plurality of metal parts are inserted into said plurality of guide holes, respectively, after said guide hole opening and closing member is switched to a closing side, and
said guide hole opening and closing member is then switched to an opening side to cause said plurality of metal parts to be dropped and accommodated into said plurality of metal part receiving recesses.

2. A method of forming vibration isolating rubber bushes according to claim 1, wherein
each of said metal parts which are to be inserted into said guide holes is configured by an inner metal part and an outer metal part, and said inner and outer metal parts are substantially concentrically placed.

3. A method of forming vibration isolating rubber bushes according to claim 1, wherein
a method of respectively inserting said plurality of metal parts into said plurality of guide holes is performed by inserting said metal parts into said guide holes of said guide hole opening and closing member which is urged toward the closing side, and then moving said guide hole opening and closing member toward the opening side against the urging force.

4. An apparatus of forming vibration isolating rubber bushes, comprising:
an upper mold half;
a lower mold half which can be laid below said upper mold half, which has a plurality of metal part receiving recesses for respectively accommodating a plurality of metal parts, and which is used for vulcanization bonding an unvulcanized rubber composition to said plurality of metal parts to form a plurality of vibration isolating rubber bushes; and
a metal part attaching jig comprising a guide member and a guide hole opening and closing member,
said guide member having a plurality of guide holes which droppingly guide said plurality of metal parts to said plurality of metal part receiving recesses of said lower mold half, respectively,
said guide hole opening and closing member being able to open said plurality of guide holes by one action in a state where said metal parts inserted into said guide holes are received.

5. An apparatus of forming vibration isolating rubber bushes according to claim 4, wherein
each of said metal parts which are to be inserted into said guide holes is configured by an inner metal part and an outer metal part, and said inner and outer metal parts can be placed concentrically with each other.

6. An apparatus of forming vibration isolating rubber bushes according to claim 4, wherein
said guide member is configured by forming a plurality of through holes in a main unit in which a slide groove for slidingly moving said guide hole opening and closing member is formed.

7. An apparatus of forming vibration isolating rubber bushes according to claim 6, wherein
each of said through holes consists of an upper through hole portion and a lower through hole portion, and cylindrical guide rings are fitted into said upper and lower through hole portions in a state where said cylindrical guide rings upward and downward protrude from said through hole portions, respectively.

8. An apparatus of forming vibration isolating rubber bushes according to claim 6, wherein
said guide hole opening and closing member is slidably inserted into said slide groove of said guide member, and urged toward the closing side by a plurality of spring means, and a plurality of openings which in the opening state allow said guide holes to be opened are formed.

9. A jig for attaching metal parts, comprising:
a guide member having a plurality of guide holes which droppingly guide a plurality of metal parts to a plurality of metal part receiving recesses of a lower mold half, respectively; and
a guide hole opening and closing member which is able to open said plurality of guide holes by one action in a state where metal parts inserted into said guide holes are received.

10. A jig for attaching metal parts according to claim 9, wherein
each of said metal parts which are to be inserted into said guide holes is configured by an inner metal part and an outer metal part, and said inner and outer metal parts can be placed concentrically with each other.

11. A jig for attaching metal parts according to claim 9, wherein
said guide member is configured by forming a plurality of through holes in a main unit in which a slide groove for slidingly moving said guide hole opening and closing member is formed.

12. A jig for attaching metal parts according to claim 11, wherein
each of said through holes consists of an upper through hole portion and a lower through hole portion, and cylindrical guide rings are fitted into said upper and lower through hole portions in a state where said cylindrical guide rings upward and downward protrude from said through hole portions, respectively.

13. A jig for attaching metal parts according to claim 11, wherein
said guide hole opening and closing member is slidably inserted into said slide groove of said guide member, and urged toward the closing side by a plurality of spring means, and a plurality of openings which in the opening state allow said guide holes to be opened are formed.
